(19) United States
(12) Patent Application Publication
(10) Pub. No.: US 2014/0324404 A1
(43) Pub. Date: Oct. 30, 2014

(54) Systems and Methods for Efficiently Creating An Electronic Description of A Building

(71) Applicant: Jose de la Torre-Bueno, Vista, CA (US)

(72) Inventor: Jose de la Torre-Bueno, Vista, CA (US)

(21) Appl. No.: 14/261,130

(22) Filed: Apr. 24, 2014

Related U.S. Application Data
(60) Provisional application No. 61/816,621, filed on Apr. 26, 2013.

(51) Int. Cl. G06F 17/50

(52) U.S. Cl. CPC G06F 17/5009
USPC 703/6

(57) ABSTRACT

Disclosed in various example embodiments is a computerized system and method adapted to create an electronic building description or model for use in running energy simulations of a building on a computerized simulation tool. Modules are provided for automatically generating an augmented input data file (IDF) including known simulation parameter data regarding a building, ranges of possible values corresponding to unknown simulation parameter data, and a module for iteratively parsing the augmented IDF into successive generations of trial IDFs that evolve in accuracy using an evolutionary optimization algorithm. When predetermined evolutionary conditions are satisfied the system outputs a sufficiently accurate electronic building description or model.

### 1.0 CROSS-REFERENCE TO RELATED APPLICATIONS

This application claims priority to and is a non-provisional of U.S. Patent Application No. 61/816,621, filed on Apr. 26, 2013, which application is incorporated herein by reference in its entirety.

### 2.0 TECHNICAL FIELD

This invention relates generally to computerized simulation tools to simulate how a building will perform with respect to energy usage, and more specifically, to systems and methods for efficiently creating an electronic description (or model) of a building for use with such computerized simulation tools.

### 3.0 BACKGROUND

Various information about a proposed or existing building may be entered into a computerized simulation tool to simulate how that building will perform with respect to energy usage. In general, the more information that is provided about a building, the more accurate the simulation tool can be in simulating the energy usage of that building in various circumstances. Once an electronic description or model is created for a specific building, then a computerized simulation tool may use that electronic description to simulate energy usage in that building under a variety of different circumstances, such as during different weather conditions or different building occupancies. Also, an accurate electronic description of a building may be used to simulate energy usage in that building under a variety of different proposed scenarios, such as upgrades of HVAC systems or windows, or architectural changes. The costs of those proposed changes may then be compared to the projected impacts on energy usage as predicted by the computerized simulation tool, and an economic analysis performed to determine which of the proposed changes are expected to provide the best return on their investment.

The information or data input into a computerized simulation tool to create an electronic description (or model) of a building may be referred to as various types of Simulation Parameters. An energy simulation tool, such as, but not limited to, for example the EnergyPlus energy simulation tool referred to in to FIG. 1, may include upwards of a thousand different Simulation Parameters in dozens of different categories. While the theoretical potential accuracy of these computerized simulation tools is impressive, in reality the quality of their output is limited by the availability of accurate data for the many different Simulation Parameters unique to a given building. Many of the Simulation Parameters require expensive, time consuming, and intrusive measurement techniques to obtain accurate data for a building, and are sometimes simply impossible to obtain for large or complex structures. What is needed is a less-expensive, faster, and less-intrusive way to gather and enter accurate data for the many Simulation Parameters unique to any building, so that the benefits of computerized simulation tools can be more fully realized in the marketplace.

### 4.0 SUMMARY

The present invention provides an elegant solution to the needs described above and provides numerous additional benefits and advantages as will be apparent to persons of skill in the art. The present system and method provides a time-saving short-cut for existing buildings, by starting with the answer of how much energy a building actually used over a specific period of time at a known location having known weather conditions, and then, after entering basic and easily observable information about the building (some of which may be obtained and entered automatically from databases), automatically causing a computerized simulation tool to run iterative simulations while selectively varying the values of the unknown Simulation Parameters until a high probability of a match is found between the data indicating how the building actually performed and an electronic description or model of that building that predicts substantially similar performance over that same time period.

However, since there may be upwards of a thousand variables (or Simulation Parameters, see e.g. the Appendix below) each having potentially numerous values, it is not feasible to serially run and compare each and every possible iteration of the potentially trillions of different combinations and permutations of Simulation Parameters, especially where even a single simulation is so complex that it can be quite taxing for a typical computer.

The present system and method overcomes this barrier by employing a multi-objective evolutionary optimization algorithm (“an evolutionary algorithm”). The system evaluates each iteration of Simulation Parameters and takes note of the values of any Simulation Parameters that tend to be consistent in “high scoring” iterations, i.e., iterations of building models that score higher than prior iterations of building models in their ability to approximate the actual performance data from the building over the same time period. The system then sets the noted Simulation Parameters to the noted values for subsequent iterations. As the iterations are progressing, the system may also periodically vary previously set values according to statistically generated algorithms to check the hypothesis that the set value was indeed a relatively correct one. This iterative process continues, with the successive building models tending to evolve toward an optimized model much faster than a standard iterative process. Once the model has evolved to the point that its predicted performance for the building sufficiently matches the building's actual performance during the same time period, then the Simulation Parameters are set and output to the user as a valid electronic description of the building. That electronic description can then be used in any of the myriad beneficial ways that electronic building descriptions are used, for instance to predict future energy uses in different scenarios and to perform cost-benefit analyses of proposed energy saving measures.

Accordingly, provided in various example embodiments is a computerized system adapted to operate on one or more computers having memory and a processor and in communication with one or more input ports, one or more output ports, and one or more databases, the system specially adapted to create an electronic building description for use in running energy simulations of a building on a computerized simulation tool, the system comprising: a module adapted to allow a user to input into a computer known simulation parameter data regarding the building; a module adapted to generate an augmented input data file (AUGIDF) comprising the known simulation parameter data and digital information representing a locus of all possible simulation parameter data values for each of a plurality of unknown simulation parameters; a module adapted to parse the AUGIDF into a first generation of trial input data files (IDF) where the computer assigns to each unknown simulation parameter of each trial IDF one value selected from the locus of all possible simulation parameter data values for that unknown simulation parameter; a module adapted to run each of the first generation of trial IDFs through a computerized simulation tool that generates energy reports for each trial IDF estimating energy use of the building during that predetermined time period by processing simulation parameter data values in each trial IDF in combination with recorded weather data regarding actual weather conditions near the building during said time period; a module adapted to compare each energy report to data corresponding to the actual energy usage of the building during said time period and to rank each energy report according to its accuracy in estimating the energy use of the building; a module adapted to generate lists of values used for each of the unknown simulation parameters by a subset of the first generation of trial IDFs that were ranked superior to other of the first generation of trial IDFs in accuracy in estimating the energy use of the building; a module adapted to parse the AUGIDF into a second generation of trial IDFs where the computer assigns to each unknown simulation parameter of each trial IDF one value selected from said computer-generated list of values corresponding to that unknown simulation parameter; a module adapted to run each of the second generation of trial IDFs through the computerized simulation tool that generates energy reports for each trial IDF estimating energy use of the building during that predetermined time period by processing simulation parameter data values in each trial IDF in combination with recorded weather data regarding actual weather conditions near the building during said time period; a module adapted to compare each energy report to data corresponding to the actual energy usage of the building during said time period and to rank each energy report according to its accuracy in estimating the energy use of the building; a module adapted to generate lists of values used for each of the unknown simulation parameters by a subset of the second generation of trial IDFs that were ranked superior to other of the second generation of trial IDFs in accuracy in estimating the energy use of the building; one or more modules adapted to repeat the foregoing parsing, running, and comparing steps in successive generations until a predetermined number of generations is reached or until the accuracy of successive generations stops improving by a predetermined amount; and a module adapted to output to a user the trial IDF with the highest measured accuracy.

Also provided in various example embodiments is a method of creating an electronic building description adapted for use in running energy simulations of a building on a computerized simulation tool, comprising the steps of: inputting into a computer module known simulation parameter data regarding the building; causing a computer to generate an AUGIDF comprising the known simulation parameter data and digital information representing a locus of all possible simulation parameter data values for each of a plurality of unknown simulation parameters; causing a computer to parse the AUGIDF into a first generation of trial IDFs where the computer assigns to each unknown simulation parameter of each trial IDF one value selected from the locus of all possible simulation parameter data values for that unknown simulation parameter; causing a computer to run each of the first generation of trial IDFs through a computerized simulation tool that generates energy reports for each trial IDF estimating energy use of the building during that predetermined time period by processing simulation parameter data values in each trial IDF in combination with recorded weather data regarding actual weather conditions near the building during said time period; causing a computer to compare each energy report to data corresponding to the actual energy usage of the building during said time period and to rank each energy report according to its accuracy in estimating the energy use of the building; causing a computer to generate lists of values used for each of the unknown simulation parameters by a subset of the first generation of trial IDFs that were ranked superior to other of the first generation of trial IDFs in accuracy in estimating the energy use of the building; causing a computer to parse the AUGIDF into a second generation of trial IDFs where the computer assigns to each unknown simulation parameter of each trial IDF one value selected from said computer-generated list of values corresponding to that unknown simulation parameter; causing a computer to run each of the second generation of trial IDFs through the computerized simulation tool that generates energy reports for each trial IDF estimating energy use of the building during that predetermined time period by processing simulation parameter data values in each trial IDF in combination with recorded weather data regarding actual weather conditions near the building during said time period; causing a computer to compare each energy report to data corresponding to the actual energy usage of the building during said time period and to rank each energy report according to its accuracy in estimating the energy use of the building; causing a computer to generate lists of values used for each of the unknown simulation parameters by a subset of the second generation of trial IDFs that were ranked superior to other of the second generation of trial IDFs in accuracy in estimating the energy use of the building; causing one or more computers to repeat the foregoing parsing, running, and comparing steps in successive generations until a predetermined number of generations is reached or until the accuracy of successive generations stops improving by a predetermined amount; and causing a computer to output the trial IDF with the highest measured accuracy.

The foregoing summary is illustrative only and is not meant to be exhaustive. Other aspects, objects, and advantages of this invention will be apparent to those of skill in the art upon reviewing the drawings, the disclosure, and the appended claims.

### 5.0 BRIEF DESCRIPTION OF THE DRAWINGS

FIG. 1 is a depiction of a computerized energy simulation tool or module known in the art called EnergyPlus, including how data typically interacts with that type of module when it is used to run energy simulations.

FIG. 2 is a diagram illustrating various aspects of one example embodiment according to the present disclosure of a system and method for efficiently creating an electronic description or model of a building for use in running energy simulations.

FIG. 3 is a screen shot showing ranges of potential values for an example simulation parameter used by an energy simulation tool.

FIG. 4 illustrates a schematic of an example computer or processing system that may implement the methodology in various example embodiments of the present disclosure.

### 6.0 DETAILED DESCRIPTION OF EXAMPLE EMBODIMENTS

Reference will now be made in detail to some specific examples of the invention, including any best mode contemplated by the inventor for carrying out the invention. Examples of these specific embodiments are illustrated in the accompanying drawings. While the invention is described in conjunction with these specific embodiments, it will be understood that it is not intended to limit the invention to the described or illustrated embodiments. On the contrary, it is intended to cover alternatives, modifications, and equivalents as may be included within the spirit and scope of the invention as defined by the appended claims. For example, while the term “building” is used herein, this term is understood broadly to mean any type of structure for which energy may be used to heat or cool it, whether a house, industrial or office building, storage facility, or any other type of structure.

In the following description, numerous specific details are set forth in order to provide a thorough understanding of the present invention. Particular example embodiments of the present invention may be implemented without some or all of these features or specific details. In other instances, components and process operations well known to persons of skill in the art have not been described in detail in order not to obscure unnecessarily the present invention.

Various techniques and mechanisms of the present invention will sometimes be described in singular form for clarity. However, it should be noted that some embodiments may include multiple iterations of a technique or multiple components, mechanisms, and the like, unless noted otherwise. Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more items or entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

### 6.1 Computerized Energy Use Simulation Tools Such as EnergyPlus Require Inputting Large Amounts of Data (Simulation Parameters) to Model the Building

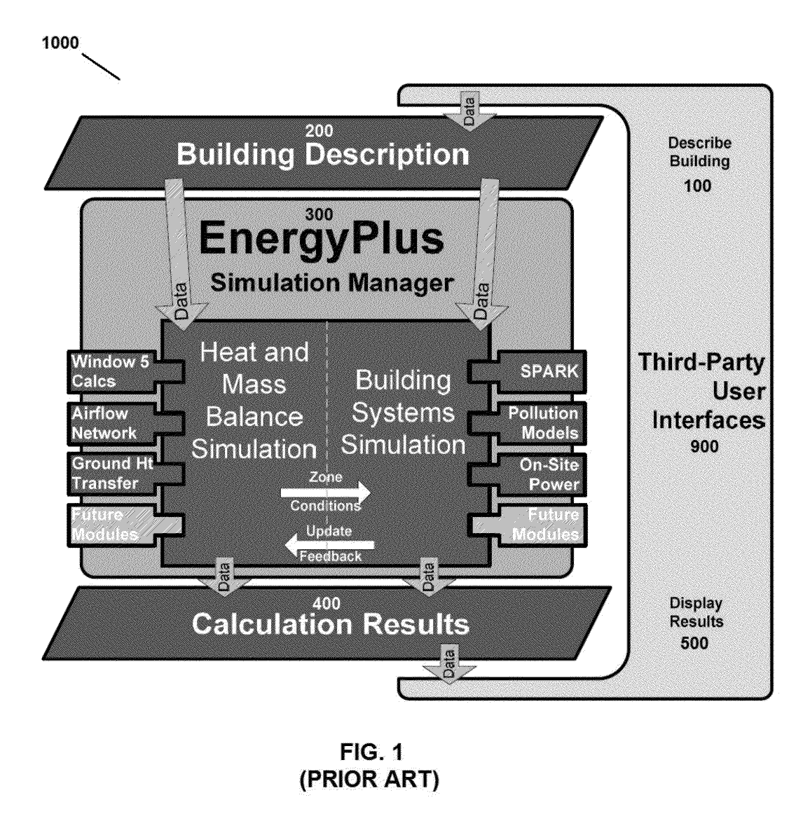

Computerized energy simulation tools are referred to herein. One example of such an energy simulation tool is known as EnergyPlus, which is functionally depicted in part in FIG. 1 as part of a building simulation system 1000. While EnergyPlus is described in detail herein, it is just one example of a computerized energy simulation tool and unless specifically claimed the invention is not limited to use with any specific software such as EnergyPlus.

EnergyPlus has its roots in prior computerized energy simulation tools known as BLAST and DOE-2, which are also known to persons of skill in the art. BLAST (Building Loads Analysis and System Thermodynamics) and DOE-2 were both developed and released in the late 1970s and early 1980s as energy and load simulation tools. Their intended audience includes, for instance, a design engineer or architect that wishes to size appropriate HVAC equipment, develop retrofit studies for life cycling cost analyses, optimize energy performance, etc. Born out of concerns driven by the energy crisis of the early 1970s and recognition that building energy consumption is a major component of the American energy usage statistics, the two programs attempted to solve the same problem from two slightly different perspectives. Both programs had their merits and shortcomings, their supporters and detractors, and solid user bases both nationally and internationally.

Like its parent programs, EnergyPlus is an energy analysis and thermal load simulation program. Based on a user's description of a building from the perspective of the building's physical make-up, associated mechanical systems, etc., EnergyPlus will calculate the heating and cooling loads necessary to maintain thermal control setpoints, conditions throughout any secondary HVAC system and coil loads, and the energy consumption of primary plant equipment as well as many other simulation details that are necessary to verify that the simulation is performing as the actual building would. Many of the simulation characteristics have been inherited from the legacy programs known as BLAST and DOE-2.

Following is a list of some of the features of the first release of EnergyPlus: Integrated, simultaneous solution where the building response and the primary and secondary systems are tightly coupled (iteration performed when necessary); Sub-hourly, user-definable time steps for the interaction between the thermal zones and the environment; variable time steps for interactions between the thermal zones and the HVAC systems (automatically varied to ensure solution stability); ASCII text based weather, input, and output files that include hourly or sub-hourly environmental conditions, and standard and user definable reports, respectively; Heat balance based solution technique for building thermal loads that allows for simultaneous calculation of radiant and convective effects at both in the interior and exterior surface during each time step; Transient heat conduction through building elements such as walls, roofs, floors, etc. using conduction transfer functions; Improved ground heat transfer modeling through links to three-dimensional finite difference ground models and simplified analytical techniques; Combined heat and mass transfer model that accounts for moisture adsorption/desorption either as a layer-by-layer integration into the conduction transfer functions or as an effective moisture penetration depth model (EMPD); Thermal comfort models based on activity, inside dry bulb, humidity, etc.; Anisotropic sky model for improved calculation of diffuse solar on tilted surfaces; Advanced fenestration calculations including controllable window blinds, electrochromic glazings, layer-by-layer heat balances that allow proper assignment of solar energy absorbed by window panes, and a performance library for numerous commercially available windows; Daylighting controls including interior illuminance calculations, glare simulation and control, luminaire controls, and the effect of reduced artificial lighting on heating and cooling; Loop based configurable HVAC systems (conventional and radiant) that allow users to model typical systems and slightly modified systems without recompiling the program source code; Atmospheric pollution calculations that predict CO2, SOx, NOx, CO, particulate matter, and hydrocarbon production for both on site and remote energy conversion; Links to other popular simulation environments/components such as WINDOWS, WINDOW6 and DElight to allow more detailed analysis of building components. While this list is not exhaustive, it is intended to give the reader an idea of the rigor and applicability of EnergyPlus to various simulation situations. More details on each of these features can be found in the various parts of the EnergyPlus documentation library, which is available online, presently at: <<http://apps1.eere.energy.gov/buildings/energyplus/energyplus_documentation.cfm>> and the documents available there are included in the accompanying Information Disclosure Statements (IDS) filed herewith and are incorporated herein by reference.

No program is able to handle every simulation situation. However, it is the intent of EnergyPlus to handle as many building and HVAC design options either directly or indirectly through links to other programs in order to calculate thermal loads and/or energy consumption on for a design day or an extended period of time (up to, including, and beyond a year). While the first version of the program contains mainly features that are directly linked to the thermal aspects of buildings, future versions of this and similar programs are expected to attempt to address other issues that are important to the built environment, such as water, electrical systems, and the like.

In addition to noting what EnergyPlus can do, it is also helpful to note its limitations. EnergyPlus is not a user interface. As depicted in FIG. 1, EnergyPlus is intended to be the simulation engine 300 around which a third-party interface 900 can be wrapped. Inputs 200 and outputs 400 are simple ASCII text that is decipherable but best left to a graphical user interface (GUI) for the user to describe the building 100 and then see the displayed results 500. This approach allows interface designers to do what they do best—produce quality tools specifically targeted toward individual markets and concerns. The availability of EnergyPlus frees up resources previously devoted to algorithm production and allows them to be redirected to interface feature development in order to keep pace with the demands and expectations of building professionals. EnergyPlus is currently not a life cycle cost (LCC) analysis tool. It produces results that can then be fed into an LCC program. In general, calculations of this nature are better left to smaller “utility” programs which can respond more quickly to changes in escalation rates and changes to methodologies as prescribed by state, federal, and defense agencies. EnergyPlus is not an architect or design engineer replacement. It does not check input, verify the acceptability or range of various parameters (expect for a limited number of very basic checks), or attempt to interpret the results. While GUI programs assist the user in fine-tuning and correcting input mistakes, EnergyPlus still operates under the “garbage in, garbage out” standard.

An energy simulation tool, such as for example the EnergyPlus energy simulation tool referred to with respect to FIG. 1, may require that data be input for hundreds of different Simulation Parameters in dozens of different categories in order to create an electronic description or model of a building. Examples of categories of Simulation Parameters may include, for instance: Compliance Objects; Location—Climate—Weather File Access; Schedules; Surface Construction Elements; Thermal Zone Description/Geometry; Advanced Surface Concepts; Detailed Ground Heat Transfer; Room Air Models; Internal Gains (People, Lights, Other internal zone equipment); Daylighting; Exterior Energy Use Equipment; Airflow; Design Objects; Node-Branch Management; Plant-Condenser Loops; Plant-Condenser Control; Plant Equipment; Water Heaters; Condenser Equipment; Plant-Condenser Flow Control; Air Distribution; Airflow Network; Zone Equipment; Air Distribution Equipment; Zone Forced Air Units; Unitary Equipment; Variable Refrigerant Flow Equipment; Radiative/Convective Units; Refrigeration; Zone Controls—Thermostats and Humidistats; Air Path; Non-Zone Equipment; Solar Collectors; Pumps; Heating and Cooling Coils; Fans; Humidifiers; Desiccant Dehumidifiers; Energy Management System (EMS); ExternalInterface; User Defined HVAC and Plant Component Models; System Availability Managers; Setpoint Managers; Controllers; Evaporative Coolers; Heat Recovery; Demand Limiting Controls; Electric Load Center-Generator Specifications; Water Systems; Operational Faults; Performance Curves; Performance Tables; Fluid Properties; HVAC Templates; and Economics.

Within these numerous categories may be hundreds upon hundreds of specific Simulation Parameters for which data may need to be entered to create an electronic description of a building. Non-limiting examples of specific Simulation Parameters in the EnergyPlus energy simulation tool are listed in the Appendix below.

### 6.2 in Various Example Embodiments, the Present System and Method May Run Computerized Energy Use Simulation Tools Iteratively Against Known Energy Use Data to Reverse-Engineer the Simulation Parameters of a Given Building

Manually measuring or obtaining the data for each of the above Simulation Parameters for a given building and then entering all that information into a computerized simulation tool such as EnergyPlus is often prohibitively time consuming, intrusive, and expensive, and sometimes the data simply cannot be obtained for a given building for technical reasons. This limits the effectiveness of and prevents the widespread adoption of such simulation tools. The present system and method provides an ingenious time-saving short-cut for existing buildings, by starting with the answer of how much energy a building actually used over a specific period of time at a known location having known weather conditions, and then, after entering basic and easily observable information about the building (some of which may be obtained and entered automatically from databases), automatically causing the computerized simulation tool to run iterative simulations while selectively varying the values of the unknown Simulation Parameters until a high probability of a match is found between the data indicating how the building actually performed and an electronic description or model of that building that predicts substantially similar performance over that same time period.

However, since there may be upwards of a thousand variables (e.g., Simulation Parameters, see e.g. Appendix below) as noted herein, each having up to numerous possible values, it is neither technically nor financially feasible to serially run and compare each and every possible iteration of the potentially trillions of different combinations and permutations of Simulation Parameters, especially where even a single simulation iteration is so complex that it can be quite taxing for a typical computer.

As an example of the use of this system and method consider a commercial building of 71,000 sqft that has 5 air conditioners of various ages with gas heat. The building is old and has leaky doors. To model the building with an energy-modeling program such as Energy Plus, several parameters of the building must be known. Some such as the area of the roof and walls and the number and type of windows can be determined from plans or a site visit or even from aerial and street view images. Parameters such as the coefficient of performance (COP) of the air conditioner(s), the annual fuel utilization efficiency (AFUE) rating of the heaters or the air changes per hour due to air leaks and open doors are much harder to measure.

If all parameters are known, the building could be modeled using actual past weather as the input to the model and the predicted energy usage should match the actual usage as measured by the gas and electric meters. If the parameters of the model are accurate it should predict the observed pattern.

An energy-modeling program is effectively solving a set of differential equations by numerical simulation. The equations describing even a simple building are so complex that there is no known method of inverting the equations to solve for the unknown parameters given what the observed energy usage is. It might seem like the unknown values of the parameters could be found by trying all combinations of plausible values given that each run of the modeling program must be given a discrete value for each parameter. Considering a real case shows that this would be prohibitively expensive of computer time.

The effective COP of air conditioners can range from about 2.5 for old units in poor condition to 6.5 for new high efficiency units. Since each run of the energy-modeling program must be given a specific value to test we might need to try 9 values ranging from 2.5 to 6 in 0.5 COP increments. Old heaters can have AFUE as low as 0.7 while modern units can be as high as 0.97. Covering this range in steps of 0.025 would need 12 values. Air changes per hour can range from 0.25 to 20 so covering this in steps of 1 could take 20 tries.

If none of these parameters interact it would take 125=(5×9+5×12+20) runs to check for the influence of these three parameters. But in fact they do interact so to find the set of parameters that make the predicted energy usage best match the actual by exhaustively testing all combination would require about 36 trillion runs (95×125×20). Clearly exhaustive testing cannot solve this problem, even for a simple system with 3 unknowns. The evolutionary algorithm disclosed here can find a good solution in this very large problem space without having to test every alternative.

Further the method can be applied repeatedly to refine the estimates. For example if the best estimate for the COP of a given air conditioner is say 5.5 the method can be run a second time with possible values of the COP of 5.2, 5.3, 5.4, 5.5, 5.6, 5.7 and 5.8. In principle this iterative method can be used on all parameters in the next run to refine all values. This cycle can be repeated as many times as required to refine the estimates of the unknown parameters.

### 6.3 in Various Example Embodiments, the Present System and Method May Employ an Evolutionary Optimization Algorithm to Efficiently Reverse-Engineer the Simulation Parameters of a Given Building

The present system and method provides a novel solution to the significant processing limitations discussed above by optionally employing an evolutionary optimization algorithm (“evolutionary algorithm”). Evolutionary algorithms use biological techniques based on biological evolution, reproduction, mutation, recombination, and natural selection to find solutions to optimization problems. Simulations that implement evolutionary algorithms act upon populations, such that individuals in a population represent candidate solutions to an optimization problem. The candidate solutions are evaluated for fitness and the population “evolves” as successive generations of the population are selected or generated based on the biological techniques. As the population evolves, overall fitness of the population tends to increase. A solution to the optimization problem is found when the fitness of the best member of the population has reached a satisfactory level. Simulations based on evolutionary algorithms can perform well for finding solutions to problems in engineering, biology, economics, robotics, and the like, because fitness evaluation functions can be tailored to fit the problems.

In various example embodiments of the present system, one or more evolutionary algorithms may be used to evolve successive iterations of building descriptions by varying the numerous unknown Simulation Parameters according to such biological modeling techniques. For instance, one or more evolutionary algorithms may evaluate each iteration of Simulation Parameters and take note of the values of any Simulation Parameters that tend to have consistent values in “high scoring” iterations, i.e., iterations of building models that score higher than prior iterations in their ability to approximate the actual performance data from the building over the same time period. The system then may set those noted Simulation Parameters to the noted consistent values for subsequent iterations. As the iterations progress, the system may also periodically vary previously set values according to statistically generated algorithms to check the hypothesis that the set value was indeed an optimal one. This iterative process continues, with the successive building models tending to evolve toward an optimized answer much faster than a standard iterative process. The evolutionary algorithm may include other or different details and features as known in the art of evolutionary algorithms. Example operational and implementation details of such algorithms are not repeated here in depth for the sake of brevity. Instead, the following references discuss in further detail example aspects of evolutionary algorithms that are potentially applicable to the present system: U.S. Pat. No. 7,996,344 B1 to Tushar Goel, entitled Multi-Objective Evolutionary Algorithm Based Engineering Design Optimization, issued Aug. 9, 2001; U.S. Pat. No. 8,195,496 B2 to Jens Gottlieb et al., entitled Combining Multiple Objective Functions In Algorithmic Problem solving, issued Jun. 5, 2012; and U.S. Pat. No. 8,577,816 B2 to Jason F. Cantin, entitled Optimized Seeding Of Evolutionary Algorithm Based Simulations, issued Nov. 5, 2013. All of the above references are incorporated herein by reference in their entireties. Once the model has evolved to the point that its predicted performance for the building sufficiently matches the building's actual performance during the same time period, then the Simulation Parameters are set and output to the user as a sufficiently valid electronic description of the building. That electronic description can then be used in any of the myriad beneficial ways that electronic building descriptions are used, for instance to predict future energy uses in different scenarios and to perform cost-benefit analyses of proposed energy saving measures.

### 6.4 Example Systems and Methods

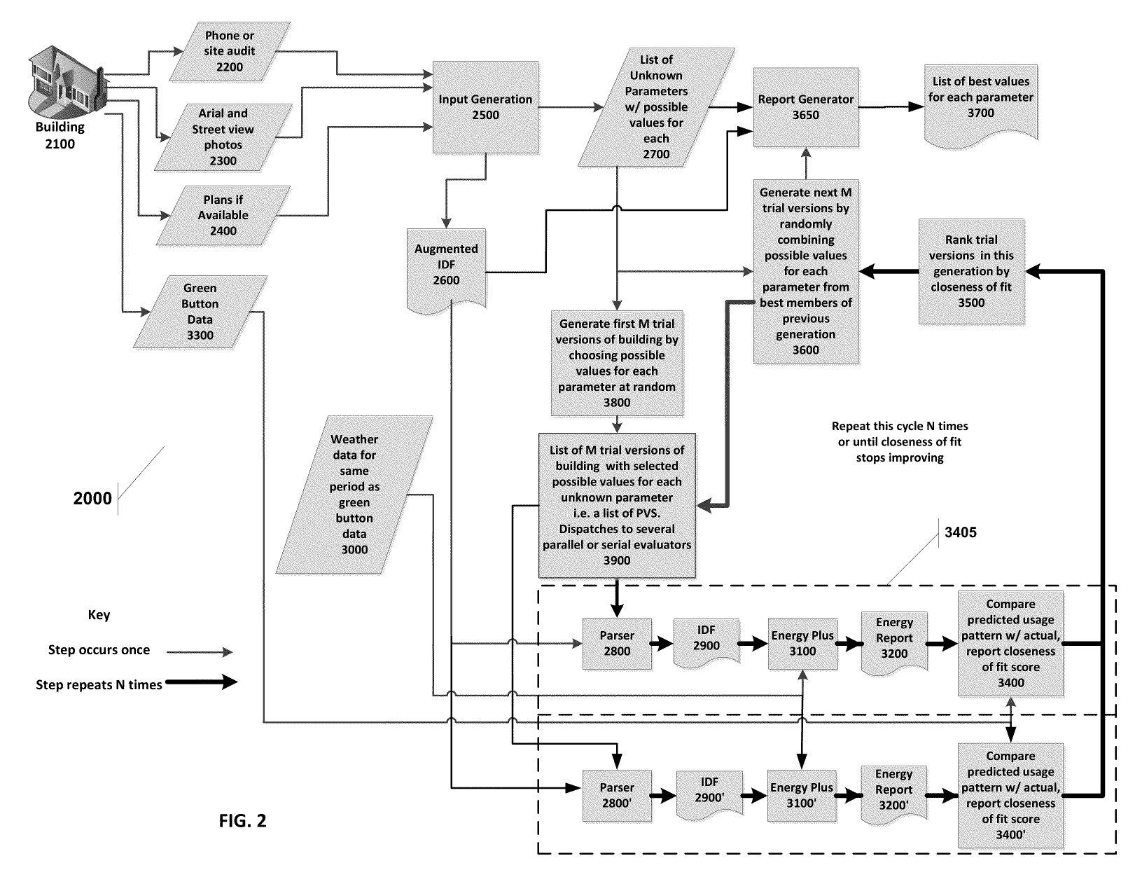

Various aspects of example embodiments of certain systems and methods will now be described with reference to FIG. 2. FIG. 2 depicts various aspects of an example system and method 2000 for creating a suitably accurate electronic description file, such as an Input Data File (“IDF”) 2900, for an existing building 2100. An IDF, as used in this disclosure, means any data file that is used as the input for the computerized simulation/modeling program.

Input Generation module 2500 may receive data needed for the the Simulation Parameters of a computerized simulation tool such as EnergyPlus, including all known Simulation Parameter data regarding the building 2100. Some parameters are obvious from the physical layout or can be extracted from plans 2400, such as, for example: dimensions, including volumes and wall/roof/floor areas; the quantity, locations, and areas of windows; the quantity and types of HVAC systems and their nameplate ratings; the quantity and types of lights. Other parameters can change over the life of the building or are much harder to establish without the plans, such as, for example: the actual rate of air infiltration; the current efficiency of the HVAC systems in their current maintenance state; the SHGC and U value of the windows; the effective R-value of the insulation. Some parameters are under control of the occupants and often can only be established by asking during a phone or site audit 2200, assuming correct answers are available. These types of parameters may include, for example: thermostat settings including any setback times (in some buildings this may be centrally controlled in which case the parameters can be read from the system); the timing of the use of lights (again some buildings may have controls that at least partially determine this); the number and usage of any electrical devices being used and their schedules; the occupancy schedule. Some parameters such as the area of the roof and walls and the number and type of windows can be determined, potentially automatically, from digital or digitized building plans or even from aerial and street view images 2300, which may in certain example embodiments be obtained automatically from databases such as Google Maps™ or similar programs.

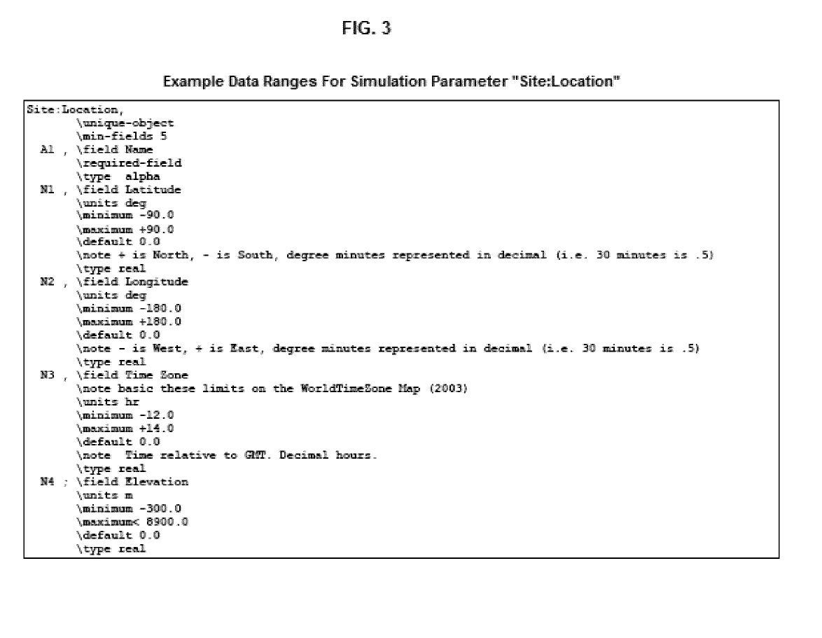

Once the known data corresponding to a subset of Simulation Parameters used by a computerized simulation tool such as an EnergyPlus module is input into the system 2000, the system 2000 builds an augmented data set using the Input Generation module 2500, referred to in this example as an Augmented IDF or AUGIDS 2600, which includes the entered data values for the known parameters. In addition to this data, the Input Generation module 2500 will automatically generate and include text strings or other digital information representing each data point comprising the locus of all possible data ranges corresponding to each of the other parameters (or some subset thereof), for which data was not entered. For example, if during the data input (i.e., 2200, 2300, 2400, 3300) no data was entered for the Simulation Parameter called Site:Location (shown in FIG. 3), then the Input Generation module 2500 would automatically generate and include text strings or other digital information representing each data point comprising the locus of all possible data ranges corresponding to the Site:Location parameter. With continuing reference to FIG. 3, this may include up to all numbers between −90.0 and +90.0 for N1, all numbers between −180.0 and +180.0 for N2, all numbers between −12.0 and +14.0 for N3, and all numbers from −300 to +8900 for N4. Parameters for which no data was entered at step 2500 may be referred to as “unknown” parameters.

The system 2000 may also generate a list of the unknown parameters 2700 and separately note the possible values for each. In various example embodiments a user may use module 2700 to manually limit a range of possible values to a smaller range based on heuristic knowledge, and may identify suggested starting points within the data ranges. For instance, in the above example the module 2700 may separately note that the Site:Location parameter was an unknown parameter and that the possible values for it may include up to all numbers between −90.0 and +90.0 for N1, all numbers between −180.0 and +180.0 for N2, all numbers between −12.0 and +14.0 for N3, and all numbers from −300 to +8900 for N4. In certain example embodiments a user may then manually limit one or more of those ranges, for instance by changing the range for N1 to −30.0 to +30.0, and may identify 0.0 as a suggested starting point within that data range.

The system 2000 may then pass the AUGIDF 2600 to a Parser module 2800. The Parser 2800 then selects a number or value for each of the unknown parameters from the corresponding possible values list in the AUGIDF 2600. The Parser's choice of number or value for each unknown parameter may be dictated by module 3800 in conjunction with module 3900, which may generate a first M trial versions of building models by choosing possible values for each unknown parameter, for instance at random, from the list provided in module 2700. Module 3800 creates a parameter value sequence (PVS) that instructs the Parser 2800 to create an IDF 2900 from the AUGIDF 2600.

Additional statistical techniques may be employed by module 3800 in addition to or instead of randomness. For example, module 3800 may instruct parser 2800 to start with a value suggested by the user in module 2700, and then vary away from that value in subsequent iterations in a normal or other predetermined distribution, such that a plot of the values of the iteratively selected values for that parameter would approximate a normal bell curve distribution, for instance, about the suggested starting value.

The Parser's 2800 choices of numbers or values for each unknown parameter are then combined with the known numbers or values to create a first iteration IDF 2900. The IDF 2900 thus comprises a first iteration set of Simulation Parameters creating a first iteration electronic description or model of the building 2100. That electronic description or model of the building 2100 represented by IDF 2900 is then inputted into a computerized simulation tool 3100, such as EnergyPlus (although other computerized modeling/simulation tools may also be used.) The computerized simulation tool 3100 may have access to or may be provided with additional data from a first database 3000, such as dynamic weather data over a relevant time period, for instance a corresponding period of time during which dynamic energy usage data for the building 2100 is available.

The computerized simulation tool 3100 then models the energy usage of the building 2100 using the first-iteration IDF 2900, preferably using dynamic weather data 3000 corresponding to a period of time during which dynamic energy usage data for the building 2100 is available. The output of the computerized simulation tool or module 3100 is an energy report 3200, which may predict the energy usage of the building 2100 dynamically over a period of time during which actual dynamic energy usage data for the building 2100 is available.

Actual dynamic energy usage data for a building 2100 may be available from a second database 3300 such as Green Button Data, for example, which presently can provide a dynamic history of energy usage of a building 2100 in fifteen-minute intervals over a given time period. Green Button Data refers to detailed individualized energy usage information for customers of electric utility companies that customers can access simply by clicking on a “Green Button” on their electric utility companies' websites. This feature is reportedly presently available for approximately 36 million electric utility customers in the United States, and the program is rapidly expanding at the urging of the Federal Government.

The system 2000 may then implement a comparing module 3400 to compare the energy usage profile predicted in the energy report 3200 to the actual energy usage profile of the building 2100 during the same time period that was modeled by the computerized simulation tool or module 3100. The magnitudes and durations of the differences observed by the comparing module 3400 may be measured and recorded in any suitable fashion, for instance by comparing respective measurements of the areas under respective time-energy usage curves. In one example embodiment the comparing module 3400 compares a specific 24 hours-worth of actual energy usage data 3300 regarding the building 2100 at 15-minute intervals, to corresponding 15-minute interval times in the energy report 3200 for the same 24-hour period, considering the actual weather data 3000 at or near the location of the building 2100 during that same period. In other example embodiments less than a days' worth of data may be compared, such as an hour's worth, or a plurality of hours' worth. Alternatively, a plurality of days' data may be compared, such as two days, three days, five days, seven days, thirty days, sixty days, ninety days, or 365 days. Any suitable duration of comparison may be used. Likewise, in various example embodiments the 15-minute intervals may be changed to any suitable length intervals, such as one minute, five minutes, thirty minutes, an hour, a plurality of hours, a day, a week, a month, or a year, for example.

The complex defined by part numbers 2800, 2900, 3100, 3200 and 3400 form the evaluation engine 3405. This engine 3405 may include several parallel processors such that multiple PVSs can be evaluated simultaneously. Illustrated in FIG. 2, is a second parallel processing chain is shown labeled 2800′, 2900′, 3100′, 3200′ and 3400′. It would be apparent to those of skill in the art that several parallel processing chains can be implemented. These parallel processing chains can be found on a single multi-processor computer, on a networked computer system, and through the internet via cloud computing. In order to determine how best to evaluate the sets of PVSs generated from Module 3800 and module 3600, the system 2000 may implement a dispatcher 3900 that determines which processing chains are available, and thus dispatches an individual or subset of PVSs to that processing chains. Module 3900 may also implement serial processing, such that once a processing chain has completed evaluating its individual PVS, it becomes available to receive another PVS. It should be noted that not all PVS will be processed in exactly the same amount of time. Rather some PVS may exert a larger computational burden on the processing chain and therefore take longer to process. In this case, other processing chains may complete their evaluations quicker and be able to take up the slack and evaluate other individual PVSs.

At ranking module 3500 the system 2000 may then rank the immediately preceding iteration of the electronic description or model (IDF 2900) of the building 2100 against prior IDF's 2900 within that first M trial versions of building models generated by module 3800. IDF's 2900 generating energy reports 3200 that more closely match the data 3300 regarding the actual energy use of the building 2100 are ranked higher than those IDF's 2900 that generate energy reports 3200 that are found to differ more from the data 3300 regarding the actual energy use of the building 2100, as measured by comparing module 3400 and 3400′.

The above steps involving modules 2800 through 3500 are repeated M times based on the first M trial versions of building models generated by module 3800. Together, these constitute a first “generation” of building models. The system 2000 creates subsequent generations of PVSs for further evaluation using Module 3600. For example, the top ten percent of building electronic descriptions or models (IDF's 2900) (i.e., those that had a closer comparison as measured by comparing module 3400 than ninety percent of the models in that generation), may be designated the “best” performing, and their parameter values recorded. The “top ten percent” example described above is just an illustrative example; any suitable cut-off may be used for determining the “best” performing models, such as the top five or any other suitable number or percentage, or those performing statistically better than average, such as three standard deviations better than average, for example. Once a cutoff has been established, the Module 3600 may select PVSs from within the cutoff and then “mate” those with each other. One such scheme is to take the top two and mate them such that a new PVS is generated that includes information from both of the parent PVSs. Another scheme would be to randomly “mate” the top PVSs together. The randomness need not be completely random, but may be weighted based on the fitness score such that it is most likely that the fittest PVS is used to “mate” with other PVSs.

As depicted in FIG. 2, subsequent generations of models after the first generation may be generated by selecting values for the unknown parameters randomly or otherwise from the list of best values from the ranking of module 3500. This is depicted in module 3600, which effectively generates the next M trial versions of electronic descriptions or models (IDF's 2900) by combining (i.e., mating) the PVSs of the best members of the immediately previous generation. The system 2000 sends the output of module 3600 through module 3900 to parser 2800, where the selected values of the unknown parameters are iteratively combined with the known parameters from the AUGIDF 2600 to generate a second generation of IDF's 2900, which are processed and their performance measured and ranked as described above with respect to modules 3100 through 3500. This constitutes a second generation, and the foregoing process may then repeat again, with the third generation using the list of best values 3700 obtained from the second generation, and so on, generation after generation until the system 2000 measures that a predetermined number N of cycles have completed, or determines that the closeness of fit of the models (i.e., the output of the comparing module 3400), stops improving by a predetermined or dynamically calculated amount (e.g., by asymptotically approaching the actual energy usage profile of the building 2100).

Optionally, once the system hones in on a set of parameter with the proper fit, the system may then perform yet another pass at the evolutionary algorithm, but this time with more granular movements within the AUGIDF. For example, if the system experienced a positive movement in fitness (i.e., the model more closely approached the actual energy use) when a particular parameter or set of parameters was changed, then the system may optionally change that particular parameter or set of parameters by a more refined amount than is currently provided in the AUGIDF. So if for example, the parameter is set in the AUGIDF at a possible values of 5, 10, 15 and 20, and the system determines that 15 is the best fit, then the system may perform additional passes at values that surround 15 more closely to determine if that results in even a better fitness.

Once module 4000 stops the automatic repeating of the iterative process indicated by modules 2800 through 3900, the system 2000 passes the optimal PVS to the report generator module 3650 that creates a report 3700 that is populated with the list of the best values for each parameter. The report generator 3650 takes the best PVS (which is just a list of numbers without actual parameter values) and references data list 2700 (and optionally the AUGIDF 2600) to create a report 3700 that includes the specific parameters and values that are represented by the PVS.

The final electronic description or model of the building IDF 2900′ may then be deemed sufficiently accurate to be used for all appropriate modeling purposes, such as to simulate energy usage in that building under a variety of different proposed scenarios, such as upgrades of HVAC systems or windows, or architectural changes. The costs of those proposed changes may then be compared to the projected impacts on energy usage as predicted by a computerized simulation tool, such as EnergyPlus, and an economic analysis performed to determine which of the proposed changes are expected to provide the best return on their investment.

Throughout this disclosure, the system 2000 has been described as having generations—i.e., sets of PVSs that are evaluated as a bulk prior to creating a new generation (or set) of PVSs. But it is not necessary to wait the entire generational set to be evaluated. Instead, the generation can be seen as being one PVS or a small set of PVSs such that the population of best member PVSs can be constantly updated by the system 2000. The benefit to such a system is that the evaluation engine 3405 can then be used as efficiently as possible. In a large-set generation-based algorithm, the evaluation engine 3405 may evaluate several PVSs, some of the individual PVSs in the set may contain data that uses significant processing power and time. So the system 2000 would be at the mercy of the slowest-calculated PVS, before it can evaluate the fitness scores and create a new generation as done by modules 3500 and 3600.

To remedy this bottleneck, the system 2000 may instead operate on a much smaller generational set (i.e., as little as one) and the population of best member PVSs (see modules 3500 and 3600) enter and exit the population individually and optionally in real-time. So, for example, the system 2000 may have as its population of best member PVSs the top fifty most fit PVSs. The system 2000 then “mates” these fifty with each other to create a new generation of PVSs that are evaluated by the evaluation engine 3405. As the evaluation engine 3405 completes the modeling of a specific PVS it reports the fitness score to module 3500, that then realigns the population of fifty if necessary. So if an individual PVS is reported that is better than one in the population for fifty, that PVS is added to the population of best member PVSs and the less fit one is dropped. This may be done in real time—i.e., as the evaluation engine 3405 reports the fitness scores of individual PVSs. And as the population of best member PVSs changes, the system 2000 may create new generations (that may be a single or very small number of PVSs).

Because the system 2000 is not waiting for an entire generation or a large generation to be evaluated before creating new generation PVSs, the system 2000 can continually feed the evaluation engine 3405 child PVSs for evaluation. This allows the system to operate more efficiently.

### 6.5 Simple Case Study

To illustrate the system and method, consider a very simple building with four parameters whose values need to be inferred from the energy use data:
Parameter 1: Thermal Absorbance of the Material, Roof Membrane
Possible Values 9, 0.7, 0.5, 0.3 or 0.1 (a total of five alternate values)
Parameter 2: Window Material which must be one of four types of glass which have values for the three components
Possible Values: (1.11, 0.86 and 0.9), (1.11, 0.44 and 0.5), (24, 0.27 and 0.64) or (0.13, 0.33 and 0.56) (a total of 4 alternate values)
Parameter 3: Lighting Occupancy Sensor
Possible Values: On, or Off (a total of two alternate values)
Parameter 4: Watts Of Lighting Per Floor Area
Possible Values: 15, 3 or 1.5 (a total of three alternate values)

All of these alternatives can be expressed in an AUGIDF by putting all the possible values for a parameter inside brackets “< >” with a number giving the parameter number and then all the possible values that parameter can take separated by vertical bars “|”. The above example translated into an AUGIDF is shown below:
Parameter 1: Thermal Absorbance of the Material, Roof Membrane
   Material,
   Roof Membrane, ! Name
   VeryRough, ! Roughness
   0.0095, !Thickness {m}
   0.16, !Conductivity {W/m-K}
   1121.29, !Density {kg/m3}
   1460, !Specific Heat {J/kg-K}
   <g1|0.9|0.7|0.5|0.3|0.1|>, !Thermal Absorptance
   0.7, !Solar Absorptance
   0.7; !Visible Absorptance
Parameter 2: Window Material
   WindowMaterial:SimpleGlazingSystem,
      Windows Simple E,
      <g2|1.11, 0.86, 0.9|1.11, 0.44, 0.5|0.24, 0.27, 0.64|0.13, 0.33, 0.56;|>
Parameter 3: Lighting Occupancy Sensor
   Lights,
      OS:Lights 1, !Name gene 21
      Thermal Zone Guest Rooms, !Zone
      <g3|Room Light no OS|Room Light OS|>,
Parameter 4: Watts Of Lighting Per Floor Area
   Watts/Area, !Design Level Calculation Method
   , !Lighting Level {W}
   <g4|15|3|1.5|>, ! Watts per Floor Area {W/m2}
   , !Watts per Person {W/person}
   , !Return Air Fraction
   , !Fraction Radiant
   , !Fraction Visible
   , ! Fraction Replaceable
   Lighting; ! End-Use Subcategory

In the first parameter above (i.e., Thermal Absorbance) some of the values are pre-populated in the AUGIDF because those values are either entered into the system as a known value or observable value, or because those values are typical for this type of building. The system may, for example, have a database of buildings and materials that can be called upon to pre-populate the AUGIDF with the values that are expected to have little to no variation.

The symbol sequence “<g1” tells the parser that what follows is the 5 possible values for the first parameter. The sequence “<g2” introduces the 4 possible values of the second parameter each of which is a sequence of three numbers. Again because each number is a measurement of a different property of a type of glass the possible values of the parameter cannot be sorted, interpolated between or in any other way treated like real numbers or even an interval scale. Finally the sequences “<g3” and “<g4” introduce the two possible values of the third parameter and the three possible values of the fourth parameter.

In all cases parameter values are set off by vertical bars so a parameter value can include punctuation if Energy Plus requires it as shown in the window example. The list of possible values for each parameter ends with a “>”.

Since the first parameter has 5 possible values, the second has 4 the third 2 and the fourth 3 there must be 120 possible versions of this building (assuming these are all the parameters who's value needs to be estimated.)

Because all the detail needed to make an IDF is encoded into the AUGIDF a shorthand description of a specific version of the building can be given by just making a list of the numerical place in the list of possible values to be chosen for each parameter. Thus the PVS {1, 1, 1, 1} would describe a building where each parameter has been assigned the first of the possible values i.e.:

0.9 for parameter 1

1.11, 0.86, 0.9; for parameter 2

Room Light no OS for parameter 3

15 for parameter 4

The PVS {5, 4, 2, 3} describes the variant of the building where the last possible value was chosen for each parameter. It follows that any sequence where each position is with the range between these two is a valid alternative version but for instance the PVS {2, 5, 1, 3} is not because the second parameter has only 4 possible values and this sequence is specifying a non existent 5^{th} value.

The task of the parser is to take a PVS and apply it to the AUGIDF to make an IDF describing a particular version of the building. The parser algorithm scans the AUGIDF for the sequence “<g” (which is chosen because it can never occur in an IDF). It looks for the first number after the g, which must be the number of the parameter. Obviously it must be a number between 1 and 4 in this example. It looks into the PVS it was given and finds the sequence number of the alternative it is to choose. It steps over that many|symbols, takes all the characters between the last|it stepped over and the next one, deletes everything between the < and > and substitutes the characters it picked up. Thus if the PVS it was given is {5, 3, 2, 3} when it hit the <g1 everything between the < and the > would be deleted and 0.1 would be substituted.

The result of this algorithm is an IDF describing a specific version of the building with each parameter given the value pointed to by its position in the PVS.

It is the evolutionary algorithm that determines which PVS the parser should use to create an IDF that is then run through EnergyPlus. And after the evolutionary algorithm has returned a characterization of the building that best fits the building, the system can then look up those values in the AUGIDF and return real values to the user. So, for example, if the PVS with the best fit is {5, 3, 2, 3} then the system would look up these positions in the AUGIDF and return a value to the user as:
Parameter 1: Thermal Absorbance of the Material, Roof Membrane
Best Value Fit: 0.1
Parameter 2: Window Material
Best Value Fit: 24, 0.27 and 0.64
Parameter 3: Lighting Occupancy Sensor
Best Value Fit: Off
Parameter 4: Watts Of Lighting Per Floor Area
Best Value Fit: 1.5

### 6.6 Use Characterized Building Parameters

Once the building has been characterized with all of the relevant parameters, then the user can attempt to optimize the building's energy efficiency. For example, the best fit parameters may indicate that the HVAC system is very inefficient such that investing money in, for example, new triple pane windows would not have a significant cost savings. Rather, replacing or reconditioning the existing HVAC would provide the most efficiency for the money. As another example, the best fit parameters may indicate the that building is extremely drafty (i.e., high air infiltration), such that weather stripping the doors and windows and adding automatic door-closing hinges to the exterior doors would result in significant cost savings. Other, more complex ways of optimizing the building, are described in U.S. patent application Ser. No. 13/949,563, filed on Jul. 24, 2013, U.S. patent application Ser. No. 12/768,243, filed on Apr. 27, 2010, U.S. Patent Application No. 61/172,992, filed on Apr. 27, 2009, and U.S. Application No. 61/880,619 filed on Sep. 20, 2013 by the same inventor of this application. These applications are incorporated herein by reference in their entireties.

### 6.7 Example Hardware

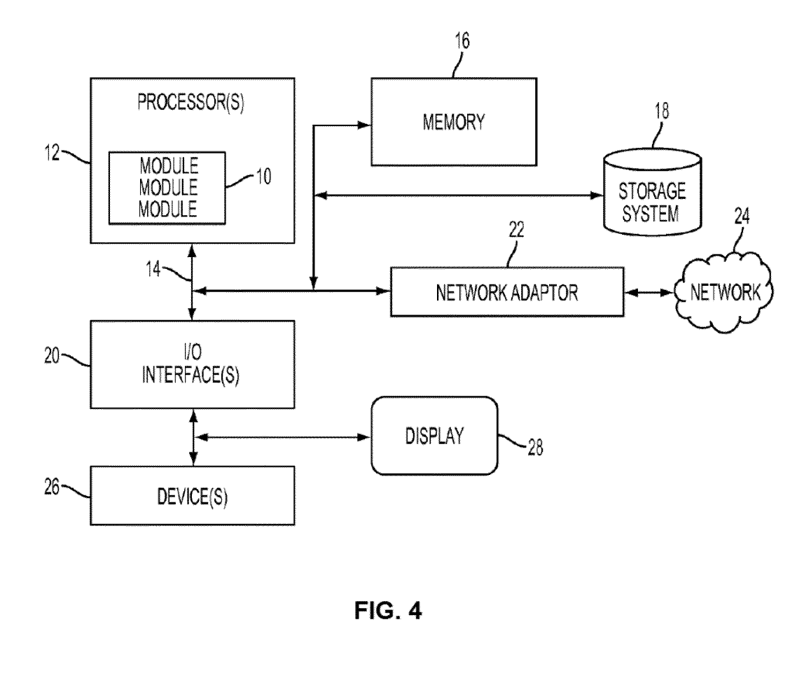

FIG. 4 illustrates a schematic of an example computer or processing system that may implement the translation/transformation methodology of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include one or more components of one or more translation/transformation modules 10 that perform the methods described herein, such as modules 2200 through 4000. The modules 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS, Lua or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

### 7.0 APPENDIX

Non-limiting examples of specific Simulation Parameters in the EnergyPlus energy simulation tool may include: SurfaceConvectionAlgorithm:Inside; SurfaceConvectionAlgorithm:Outside; HeatBalanceSettings:ConductionFiniteDifference; Output:Diagnostics; Output:DebuggingData; Output:PreprocessorMessage; ZoneCapacitanceMultiplier:ResearchSpecial; Meter:Custom; Meter: CustomDecrement; Compliance:Building; Site:Location; SizingPeriod:DesignDay; SizingPeriod:WeatherFileDays; SizingPeriod:WeatherFileConditionType; RunPeriod:CustomRange; RunPeriodControl:SpecialDays; RunPeriodControl:DaylightSavingTime; WeatherProperty:SkyTemperature; Site:WeatherStation; Site:HeightVariation; Site:GroundTemperature:BuildingSurface; Site:GroundTemperature:Shallow; Site:GroundTemperature:Deep; Site:GroundTemperature:FCfactorMethod; Site:GroundReflectance; Site:GroundReflectance:SnowModifier; Site:WaterMainsTemperature; Site:Precipitation; Site: SolarAndVisibleSpectrum; Site:SpectrumData; Climate Group Outputs; Schedule:Day:Hourly; Schedule:Day:Interval; Schedule:Day:List; Schedule:Week:Daily; Schedule:Week:Compact; Schedule:Year; Schedule:Compact; Schedule:Constant; Schedule:File; Material:NoMass; Material:InfraredTransparent; Material:AirGap; MaterialProperty:MoisturePenetrationDepth:Settings; MaterialProperty:PhaseChange; MaterialProperty:VariableThermalConductivity; MaterialProperty:HeatAndMoistureTransfer: Settings; MaterialProperty:HeatAndMoistureTransfer: Sorptionlsotherm; MaterialProperty:HeatAndMoistureTransfer: Suction; MaterialProperty:HeatAndMoistureTransfer:Redistribution; MaterialProperty:HeatAndMoistureTransfer:Diffusion; MaterialProperty:HeatAndMoistureTransfer:ThermalConductivity; WindowMaterial:Glazing; WindowMaterial:Glazing:RefractionExtinctionMethod; WindowMaterial:GlazingGroup:Thermochromic; WindowMaterial:GlazingGroup:Thermochromic Outputs; WindowMaterial:Gas; WindowMaterial:GasMixture; WindowMaterial:Gap; WindowGap:DeflectionState; WindowGap:SupportPillar; WindowMaterial:SimpleGlazingSystem; WindowMaterial:Shade; WindowMaterial:Blind; WindowMaterial:ComplexShade; WindowMaterial:Screen; WindowMaterial:Shade:EquivalentLayer; WindowMaterial:Drape:EquivalentLayer; WindowMaterial:Blind:EquivalentLayer; WindowMaterial:Screen:EquivalentLayer; WindowMaterial:Glazing:EquivalentLayer; WindowMaterial:Gap:EquivalentLayer; Material:RoofVegetation; MaterialProperty:GlazingSpectralData; Site:GroundTemperature:FCfactorMethod; Construction: CfactorUndergroundWall; Construction:FfactorGroundFloor; Construction:InternalSource; Construction: ComplexFenestrationState; WindowThermalModel:Params; Matix:TwoDimension; Construction:WindowEquivalentLayer; Construction:WindowDataFile; ZoneGroup; ZoneGroup Outputs; Wall:Exterior; Wall:Adiabatic; Wall:Underground; Wall:Interzone; Ceiling:Adiabatic; Ceiling:Interzone; Floor:GroundContact; Floor:Adiabatic; Floor:Interzone; Window:Interzone; Door:Interzone; GlazedDoor:Interzone; Wall:Detailed; RoofCeiling:Detailed; Floor:Detailed; BuildingSurface:Detailed; FenestrationSurface:Detailed; Shading:Site, Shading:Building; Shading:Site:Detailed, Shading:Building:Detailed; Shading:Overhang; Shading:Overhang:Projection; Shading:Fin; Shading:Fin:Projection; Shading:Zone:Detailed; ShadingProperty:Reflectance; WindowProperty:ShadingControl; WindowProperty:FrameAndDivider; WindowProperty:AirflowControl; WindowProperty:StormWindow; SurfaceProperty:HeatTransferAlgorithm; SurfaceProperty:HeatTransferAlgorithm:MultipleSurface; SurfaceProperty:HeatTransferAlgorithm: SurfaceList; SurfaceProperty:HeatTransferAlgorithm:Construction; SurfaceControl:MoveableInsulation; SurfaceProperty:OtherSideCoefficients; SurfaceProperty:OtherSideCoefficients Outputs; SurfaceProperty:OtherSideConditionsModel; SurfaceProperty:OtherSideConditionsModel Outputs; SurfaceConvectionAlgorithm:Inside:AdaptiveModelSelections; SurfaceConvectionAlgorithm:Outside:AdaptiveModelS elections; SurfaceConvectionAlgorithm:Inside:UserCurve; SurfaceConvectionAlgorithm:Outside:UserCurve; SurfaceProperty:ConvectionCoefficients; SurfaceProperty:ConvectionCoefficients:MultipleSurface; SurfaceProperties:VaporCoefficients; SurfaceProperty:ExteriorNaturalVentedCavity; SurfaceProperty:ExteriorNaturalVentedCavity Outputs; SurfaceProperty:SolarIncidentInside; ComplexFenestrationProperty: SolarAbsorbedLayers; ZoneProperty:UserViewFactors:bySurfaceName; GroundHeatTransfer:Control; RoomAir:TemperaturePattern:UserDefined; RoomAir:TemperaturePattern:ConstantGradient; RoomAir:TemperaturePattern:TwoGradient; RoomAir:TemperaturePattern:NondimensionalHeight; RoomAir:TemperaturePattern:SurfaceMapping; RoomAir:Node; RoomAirSettings:OneNodeDisplacementVentilation; RoomAirSettings:ThreeNodeDisplacementVentilation; RoomAirSettings:CrossVentilation; RoomAirSettings:UnderFloorAirDistributionInterior; RoomAirSettings:UnderFloorAirDistributionExterior; RoomAir:TemperaturePattern:TwoGradient Outputs; ZoneContaminantSourceAndSink: CarbonDioxide; ZoneContaminantSourceAndSink:CarbonDioxide Outputs; ZoneContaminantSourceAndSink: GenericContaminant: Constant; ZoneContaminantSourceAndSink:GenericContaminant:Constant Outputs; SurfaceContaminantSourceAndSink:GenericContaminant:PressureDriven; SurfaceContaminantSourceAndSink:GenericContaminant:PressureDriven; ZoneContaminantSourceAndSink: GenericContaminant: CutoffModel; ZoneContaminantSourceAndSink: GenericContaminant: CutoffModel; ZoneContaminantSourceAndSink:GenericContaminant:DecaySource; ZoneContaminantSourceAndSink:GenericContaminant:DecaySource; SurfaceContaminantSourceAndSink:GenericContaminant:BoudaryLayerD; SurfaceContaminantSourceAndSink:GenericContaminant:BoundaryLayer; SurfaceContaminantSourceAndSink:GenericContaminant:DepositionVelo; SurfaceContaminantSourceAndSink:GenericContaminant:DepositionVelo; ZoneContaminantSourceAndSink:GenericContaminant:DepositionRateSi; ZoneContaminantSourceAndSink:GenericContaminant:DepositionRateSi; ZoneBaseboard: OutdoorTemperatureControlled; ZoneBaseboard: OutdoorTemperatureControlled Output; Daylighting:Controls; Daylighting:DELight:Controls; Daylighting:DELight:ReferencePoint; Daylighting:DELight:ComplexFenestration; Output:IlluminanceMap; OutputControl:IlluminanceMap:Style; DaylightingDevice:Tubular; DaylightingDevice:Shelf; DaylightingDevice:LightWell; Exterior:Lights; Exterior:FuelEquipment; Exterior:WaterEquipment; Zonelnfiltration:DesignFlowRate; Zonelnfiltration:EffectiveLeakageArea; Zonelnfiltration:FlowCoefficient; ZoneVentilation:DesignFlowRate; ZoneVentilation:WindandStackOpenArea; ZoneAirBalance:OutdoorAir; ZoneAirBalance:OutdoorAir Outputs; ZoneCoolTower:Shower; ZoneCoolTower:Shower Outputs; DesignSpecification:OutdoorAir; DesignSpecification:ZoneAirDistribution; Sizing:Parameters; OutputControl:Sizing:Style; Sizing:Zone; Sizing:System; Sizing:Plant; HVAC: Primary and Secondary Systems; Pipe:Adiabatic; Pipe:Adiabatic:Steam; Pipe:Indoor; Pipe:Indoor Outputs; Pipe:Outdoor; Pipe:Outdoor Outputs; Pipe:Underground; Pipe:Underground Outputs; PipingSystem:Underground Class Objects; PipingSystem:Underground:Domain; PipingSystem:Underground:PipeCircuit; PipingSystem:Underground:PipeSegment; PipingSystem:Underground Outputs; PlantEquipmentOperation:Uncontrolled; PlantEquipmentOperation:CoolingLoad; PlantEquipmentOperation:HeatingLoad; PlantEquipmentOperation:OutdoorDryBulb; PlantEquipmentOperation:OutdoorWetBulb; PlantEquipmentOperation:OutdoorRelativeHumidity; PlantEquipmentOperation:OutdoorDewpoint; PlantEquipmentOperation:OutdoorDryBulbDifference; PlantEquipmentOperation:OutdoorWetBulbDifference; PlantEquipmentOperation:OutdoorDewpointDifference; PlantEquipmentOperation:ComponentSetpoint; Chiller:Absorption; Chiller:Absorption:Indirect; Chiller:ConstantCOP; Chiller:Electric; Chiller:Electric:EIR; Chiller:Electric:ReformulatedElR; Chiller:EngineDriven; Chiller:CombustionTurbine; ChillerHeater:Absorption:DirectFired; ChillerHeater:Absorption:DoubleEffect; Boiler:HotWater; Boiler:HotWater Outputs; Boiler:Steam; HeatPump:WaterToWater:EquationFit:Cooling; HeatPump:WaterToWater:EquationFit:Heating; HeatPump:WaterToWater:ParameterEstimation:Cooling; HeatPump:WaterToWater:ParameterEstimation:Heating; PlantComponent:TemperatureSource; PlantComponent:TemperatureSource Outputs; ChillerHeaterPerformance:Electric:EIR; ChillerHeaterPerformance:Electric:EIR Outputs; ThermalStorage:Ice:Simple; ThermalStorage:Ice:Detailed; ThermalStorage:ChilledWater:Mixed; ThermalStorage:ChilledWater:Stratified; WaterHeater:Mixed; WaterHeater:Stratified; WaterHeater:Sizing; WaterHeater:HeatPump; CoolingTower: SingleSpeed; CoolingTower:TwoSpeed; CoolingTower:VariableSpeed:Merkel; CoolingTower:VariableSpeed:Merkel Outputs; CoolingTower:VariableSpeed; CoolingTowerPerformance:CoolTools; CoolingTowerPerformance:CoolTools Outputs; CoolingTowerPerformance:YorkCalc; CoolingTowerPerformance:YorkCalc Outputs; EvaporativeFluidCooler:SingleSpeed; EvaporativeFluidCooler:TwoSpeed; FluidCooler:SingleSpeed; FluidCooler:TwoSpeed; GroundHeatExchanger:Vertical; GroundHeatExchanger:Pond; GroundHeatExchanger:Surface; GroundHeatExchanger:HorizontalTrench; HeatExchanger:FluidToFluid; Connector:Splitter, Connector:Mixer; Connector:Splitter; Connector:Mixer; AirLoopHVAC:ControllerList; AirLoopHVAC:OutdoorAirSystem; AirLoopHVAC:OutdoorAirSystem:EquipmentList; OutdoorAir:Node; Outdoor Air Node outputs:; OutdoorAir:NodeList; OutdoorAir:Mixer; AirflowNetwork:SimulationControl; AirflowNetwork:Multizone:Zone; AirflowNetwork:Multizone:Surface; AirflowNetwork:MultiZone:ReferenceCrackConditions; AirflowNetwork:MultiZone: Surface: Crack; AirflowNetwork:MultiZone:Surface:EffectiveLeakageArea; AirflowNetwork:MultiZone:Component:DetailedOpening; AirflowNetwork:MultiZone:Component:HorizontalOpening; AirflowNetwork:MultiZone:Component:SimpleOpening; AirflowNetwork:MultiZone:Component:ZoneExhaustFan; AirflowNetwork:MultiZone:ExternalNode; AirflowNetwork:MultiZone:WindPressureCoefficientArray; AirflowNetwork:MultiZone:WindPressureCoefficientValues; AirflowNetwork:Distribution:Node; AirflowNetwork:Distribution:Component:Leak; AirflowNetwork:Distribution: Component:LeakageRatio; AirflowNetwork:Distribution:Component:Duct; AirflowNetwork:Distribution:Component:Fan; AirflowNetwork:Distribution:Component:Coil; AirflowNetwork:Distribution:Component:HeatExchanger; AirflowNetwork:Distribution: Component:TerminalUnit; AirflowNetwork:Distribution: Component: ConstantPressureDrop; AirflowNetwork:Distribution:Linkage; ZoneHVAC:AirDistributionUnit; ZoneHVAC:EquipmentConnections; ZoneHVAC:EquipmentList; AirTerminal:SingleDuct:Uncontrolled; AirTerminal:SingleDuct:ConstantVolume:Reheat; AirTerminal:SingleDuct:VAV:Reheat; AirTerminal:SingleDuct:VAV:Reheat:VariableSpeedFan; AirTerminal:SingleDuct:VAV:HeatAndCool:Reheat; AirTerminal:SingleDuct:VAV:NoReheat; AirTerminal:SingleDuct:VAV:HeatAndCool:NoReheat; AirTerminal:SingleDuct:SeriesPIU:Reheat; AirTerminal:SingleDuct:ParallelPIU:Reheat; AirTerminal:SingleDuct:ConstantVolume:FourPipeInduction; AirTerminal:SingleDuct:ConstantVolume:CooledBeam; AirTerminal: SingleDuct:InletSideMixer; AirTerminal: SingleDuct: SupplySideMixer; AirTerminal:DualDuct:ConstantVolume; AirTerminal:DualDuct:VAV; AirTerminal:DualDuct:VAV:OutdoorAir; ZoneHVAC:IdealLoadsAirSystem; ZoneHVAC:IdealLoadsAirSystem Outputs; ZoneHVAC:FourPipeFanCoil; ZoneHVAC:UnitVentilator; ZoneHVAC:UnitHeater; ZoneHVAC:EvaporativeCoolerUnit; ZoneHVAC:EvaporativeCoolerUnit Outputs; ZoneHVAC:OutdoorAirUnit; ZoneHVAC:OutdoorAirUnit:EquipmentList; ZoneHVAC:WindowAirConditioner; ZoneHVAC:PackagedTerminalAirConditioner; ZoneHVAC:PackagedTerminalHeatPump; ZoneHVAC:RefrigerationChillerSet; ZoneHVAC:WaterToAirHeatPump; ZoneHVAC:Dehumidifier:DX; ZoneHVAC:EnergyRecoveryVentilator; ZoneHVAC:TerminalUnit:VariableRefrigerantFlow; AirLoopHVAC:UnitarySystem; UnitarySystemPerformance:HeatPump:Multispeed; AirLoopHVAC:Unitary:Furnace:HeatCool; AirLoopHVAC:UnitaryHeatCool; AirLoopHVAC:UnitaryHeatPump:AirToAir; AirLoopHVAC:UnitaryHeatPump:AirToAir:MultiSpeed; AirLoopHVAC:Unitary:Furnace:HeatOnly; AirLoopHVAC:UnitaryHeatOnly; AirLoopHVAC:UnitaryHeatPump:WaterToAir; AirLoopHVAC:UnitaryHeatCool:VAVChangeoverBypass; AirConditioner:VariableRefrigerantFlow; ZoneHVAC:Baseboard:RadiantConvective:Water; ZoneHVAC:Baseboard:RadiantConvective:Steam; ZoneHVAC:Baseboard:RadiantConvective:Electric; ZoneHVAC:Baseboard:Convective:Water; ZoneHVAC:Baseboard:Convective:Electric; ZoneHVAC:LowTemperatureRadiant:VariableFlow; ZoneHVAC:LowTemperatureRadiant:ConstantFlow; ZoneHVAC:LowTemperatureRadiant:Electric; ZoneHVAC:LowTemperatureRadiant:SurfaceGroup; ZoneHVAC:HighTemperatureRadiant; ZoneHVAC:VentilatedSlab; ZoneHVAC:VentilatedSlab:SlabGroup; Refrigeration: CompressorRack; Refrigeration:Case; Refrigeration:Case Outputs; Refrigeration:CaseAndWalklnList; Refrigeration:WalkIn; Refrigeration:System; Refrigeration:TranscriticalSystem; Refrigeration:Compressor; Refrigeration: CompressorList; Refrigeration:Subcooler; Refrigeration: Condenser:AirCooled; Refrigeration:Condenser:EvaporativeCooled; Refrigeration:Condenser:WaterCooled; Refrigeration:Condenser:Cascade; Refrigeration: GasCooler:AirCooled; Refrigeration:TransferLoadList; Refrigeration:SecondarySystem; Refrigeration:AirChiller; ZoneControl:Thermostat; ThermostatSetpoint:SingleHeating; ThermostatSetpoint:SingleCooling; ThermostatSetpoint:SingleHeatingOrCooling; ThermostatSetpoint:DualSetpoint; ZoneControl:Thermostat:OperativeTemperature; ZoneControl:Thermostat:TemperatureAndHumidity; ZoneControl:Thermostat:StagedDualSetpoint; ZoneControl:Humidistat; ZoneControl:Thermostat:ThermalComfort; ThermostatSetpoint:ThermalComfort:Fanger: SingleHeating; ThermostatSetpoint:ThermalComfort:Fanger: SingleCooling; ThermostatSetpoint:ThermalComfort:Fanger:SingleHeatingOrCooling; ThermostatSetpoint:ThermalComfort:Fanger:DualSetpoint; ZoneControl:ContaminantController; AirLoopHVAC:SupplyPath, AirLoopHVAC:ReturnPath; AirLoopHVAC:SupplyPath; AirLoopHVAC:ReturnPath; AirLoopHVAC:ReturnPlenum; AirLoopHVAC:SupplyPlenum; AirLoopHVAC:ZoneSplitter; AirLoopHVAC:ZoneMixer; LoadProfile:Plant; SolarCollector:FlatPlate:Water; SolarCollectorPerformance:FlatPlate; SolarCollectorPerformance:FlatPlate Output; SolarCollector:IntegralCollectorStorage; SolarCollectorPerformance:IntegralCollectorStorage; SolarCollector:FlatPlate:PhotovoltaicThermal; SolarCollectorPerformance:PhotovoltaicThermal:Simple; SolarCollector:UnglazedTranspired; SolarCollector:UnglazedTranspired:MultiSystem; Pump:VariableSpeed; Pump:ConstantSpeed; Pump:VariableSpeed:Condensate; HeaderedPumps:ConstantSpeed; HeaderedPumps:VariableSpeed; Coil:Cooling:Water; Coil:Heating:Water; Coil:Heating:Steam; Heating Coil (Steam) Outputs:; Coil:Heating:Electric; Coil:Heating:Electric:MultiStage; Coil:Heating:Desuperheater; Coil:Cooling:DX:VariableRefrigerantFlow; Coil:Heating:DX:VariableRefrigerantFlow; Coil:Heating:Gas; Coil:Heating:Gas:MultiStage; Coil:Cooling:Water:DetailedGeometry; Coil:Cooling:DX:SingleSpeed; Coil:Cooling:DX:TwoSpeed; Coil:Cooling:DX:TwoStageWithHumidityControlMode; Coil:Cooling:DX:MultiSpeed; Coil:Cooling:DX:VariableSpeed; CoilPerformance:DX:Cooling; Coil:Heating:DX:SingleSpeed; Coil:Heating:DX:MultiSpeed; Coil:Heating:DX:MultiSpeed; Coil:Heating:DX:VariableSpeed; Coil:WaterHeating:Desuperheater; CoilSystem:Cooling:DX; CoilSystem:Heating:DX; CoilSystem:Cooling:DX:HeatExchangerAssisted; CoilSystem:Cooling:DX:HeatExchangerAssisted Outputs; CoilSystem:Cooling:Water:HeatExchangerAssisted; CoilSystem:Cooling:Water:HeatExchangerAssisted Outputs; Coil:WaterHeating:AirToWaterHeatPump; Coil:WaterHeating:AirToWaterHeatPump Outputs; Coil:Cooling:WaterToAirHeatPump:ParameterEstimation; Coil:Cooling:WaterToAirHeatPump:EquationFit; Coil:Cooling:WaterToAirHeatPump:VariableSpeedEquationFit; Coil:Heating:WaterToAirHeatPump:ParameterEstimation; Coil:Heating:WaterToAirHeatPump:EquationFit; Coil:Heating:WaterToAirHeatPump:VariableSpeedEquationFit; Coil:Cooling:DX:SingleSpeed:ThermalStorage; Coil:Cooling:DX:SingleSpeed:ThermalStorage Outputs; Fan: ConstantVolume; Fan:OnOff; Fan:VariableVolume; Fan:ZoneExhaust; FanPerformance:NightVentilation; Fan:ComponentModel; Humidifier:Steam:Electric; Dehumidifier:Desiccant:NoFans; Dehumidifier:Desiccant:System; EnergyManagementSystem:Sensor; EnergyManagementSystem:Actuator; EnergyManagementSystem:ProgramCallingManager; EnergyManagementSystem:Program; EnergyManagementSystem:Subroutine; EnergyManagementSystem:GlobalVariable; EnergyManagementSystem:OutputVariable; EnergyManagementSystem:MeteredOutputVariable,; EnergyManagementSystem:TrendVariable; EnergyManagementSystem:InternalVariable; EnergyManagementSystem:CurveOrTableIndexVariable; EnergyManagementSystem:ConstructionIndexVariable; ExternalInterface:Schedule; ExternalInterface:Actuator; ExternalInterface:Variable; ExternalInterface:FunctionalMockupUnitImport; ExternalInterface:FunctionalMockupUnitImport:From:Variable; ExternalInterface:FunctionalMockupUnitImport:To:Schedule; ExternalInterface:FunctionalMockupUnitImport:To:Actuator; ExternalInterface:FunctionalMockupUnitImport:To:Variable; ExternalInterface:FunctionalMockupUnitExport:From:Variable; ExternalInterface:FunctionalMockupUnitExport:To:Schedule; ExternalInterface:FunctionalMockupUnitExport:To:Actuator; ExternalInterface:FunctionalMockupUnitExport:To:Variable; ZoneHVAC:ForcedAir:UserDefined; AirTerminal:SingleDuct:UserDefined; Coil:UserDefined; PlantComponent:UserDefined; PlantEquipmentOperation:UserDefined; AvailabilityManager:Scheduled; AvailabilityManager:ScheduledOn; AvailabilityManager:ScheduledOn Outputs; AvailabilityManager:ScheduledOff; AvailabilityManager:ScheduledOff Outputs; AvailabilityManager:NightCycle; AvailabilityManager:NightCycle Outputs; AvailabilityManager:DifferentialThermostat; AvailabilityManager:DifferentialThermostat Outputs; AvailabilityManager:HighTemperatureTurnOff; AvailabilityManager:HighTemperatureTurnOff Outputs; AvailabilityManager:HighTemperatureTurnOn; AvailabilityManager:HighTemperatureTurnOn Outputs; AvailabilityManager:LowTemperatureTurnOff; AvailabilityManager:LowTemperatureTurnOff Outputs; AvailabilityManager:LowTemperatureTurnOn; AvailabilityManager:LowTemperatureTurnOn Outputs; AvailabilityManager:NightVentilation; AvailabilityManager:HybridVentilation; AvailabilityManager:HybridVentilation Outputs; AvailabilityManager:OptimumStart; AvailabilityManager:OptimumStart Outputs; SetpointManager:Scheduled; SetpointManager:Scheduled:DualSetpoint; SetpointManager:OutdoorAirReset; SetpointManager:SingleZone:Reheat; SetpointManager:SingleZone:Heating; SetpointManager:SingleZone:Cooling; SetpointManager:SingleZone:Humidity:Minimum; SetpointManager:SingleZone:Humidity:Maximum; SetpointManager:MixedAir; SetpointManager:OutdoorAirPretreat; SetpointManager:Warmest; SetpointManager:Coldest; SetpointManager:ReturnAirBypassFlow; SetpointManager:WarmestTemperatureFlow; SetpointManager:WarmestTemperatureFlow Outputs; SetpointManager:MultiZone:Cooling:Average; SetpointManager:MultiZone:Heating:Average; SetpointManager:MultiZone:MinimumHumidity:Average; SetpointManager:MultiZone:MaximumHumidity:Average; SetpointManager:MultiZone:Humidity:Minimum; SetpointManager:MultiZone:Humidity:Maximum; SetpointManager:FollowOutdoorAirTemperature; SetpointManager:FollowSystemNodeTemperature; SetpointManager:FollowGroundTemperature; SetpointManager:CondenserEnteringReset; SetpointManager:CondenserEnteringReset:Ideal; SetpointManager:SingleZone:OneStageCooling; SetpointManager:SingleZoneOneStageHeating; Controller:WaterCoil; Controller:OutdoorAir; Controller:OutdoorAir Outputs; Controller:MechanicalVentilation; ZoneHVAC:EnergyRecoveryVentilator:Controller; EvaporativeCooler:Direct:CelDekPad; EvaporativeCooler:Direct:CelDekPad Outputs; EvaporativeCooler:Direct:ResearchSpecial; EvaporativeCooler:Direct:ResearchSpecial Outputs; EvaporativeCooler:Indirect:CelDekPad; EvaporativeCooler:Indirect:CelDekPad Outputs; EvaporativeCooler:Indirect:WetCoil; EvaporativeCooler:Indirect:WetCoil Outputs; EvaporativeCooler:Indirect:ResearchSpecial; EvaporativeCooler:Indirect:ResearchSpecial Outputs; HeatExchanger:AirToAir:FlatPlate; HeatExchanger:AirToAir:FlatPlate Outputs; HeatExchanger:AirToAir:SensibleAndLatent; HeatExchanger:AirToAir:SensibleAndLatent Outputs; HeatExchanger:Desiccant:BalancedFlow; HeatExchanger:Desiccant:BalancedFlow Outputs; HeatExchanger:Desiccant:BalancedFlow:PerformanceDataTypel; HeatExchanger:Desiccant:BalancedFlow:PerformanceDataTypel; DemandManager:ExteriorLights; DemandManager:ExteriorLights Outputs; DemandManager:Lights; DemandManager:Lights Outputs; DemandManager:ElectricEquipment; DemandManager:ElectricEquipment Outputs; DemandManager:Thermostats; DemandManager:Thermostats Outputs; ElectricLoadCenter:Transformer; ElectricLoadCenter:Transformer Outputs; ElectricLoadCenter:Distribution; ElectricLoadCenter:Distribution Outputs; ElectricLoadCenter:Generators; ElectricLoadCenter:Generators Outputs; ElectricLoadCenter:Inverter:Simple; ElectricLoadCenter:Inverter:FunctionOfPower; ElectricLoadCenter:Inverter:LookUpTable; ElectricLoadCenter:Storage:Simple; ElectricLoadCenter:Storage:Simple Outputs; ElectricLoadCenter:Storage: Battery; ElectricLoadCenter: Storage:Battery Outputs; Generator:InternalCombustionEngine; Generator:InternalCombustionEngine Outputs; Generator: CombustionTurbine; Generator: CombustionTurbine Outputs; Generator:MicroTurbine; Generator:MicroTurbine Outputs; Generator:MicroCHP; Generator:MicroCHP:NonNormalizedParameters; Generator:MicroCHP Outputs; Generator:FuelCell; Generator:FuelCell Outputs; Generator:FuelCell:PowerModule; Generator:FuelCell:StackCooler; Generator:FuelCell:AirSupply; Generator:FuelCell:WaterSupply; Generator:FuelCell:AuxiliaryHeater; Generator:FuelCell:ElectricalStorage; Generator:FuelCell:Inverter; Generator:FuelSupply; Generator:FuelSupply Outputs; Generator:Photovoltaic; Generator:Photovoltaic Outputs; PhotovoltaicPerformance:Simple; PhotovoltaicPerformance:EquivalentOne-Diode; PhotovoltaicPerformance:Sandia; Generator:WindTurbine; Generator:WindTurbine Outputs; WaterUse:Equipment; WaterUse:Equipment Outputs; WaterUse:Connections; WaterUse:Connections Outputs; WaterUse:Storage; WaterUse:Storage Outputs; WaterUse:RainCollector; WaterUse:RainCollector Outputs; WaterUse:Well; WaterUse:Well Outputs; FaultModel:TemperatureSensorOffset:OutdoorAir; FaultModel:HumiditySensorOffset:OutdoorAir; FaultModel:EnthalpySensorOffset:OutdoorAir; FaultModel:TemperatureSensorOffset:ReturnAir; FaultModel:EnthalpySensorOffset:ReturnAir; Curve:Linear; Curve:QuadLinear; Curve:Quadratic; Curve:Cubic; Curve:Quartic; Curve:Exponent; Curve:Bicubic; Curve:Biquadratic; Curve:QuadraticLinear; Curve:Triquadratic; Curve:Functional:PressureDrop; Curve:FanPressureRise; Curve:ExponentialSkewNormal; Curve: Sigmoid; Curve:RectangularHyperbola1; Curve:RectangularHyperbola2; Curve:ExponentialDecay; Curve:DoubleExponentialDecay; Table:OnelndependentVariable; Table:TwoIndependentVariables; Table:MultiVariableLookup; FluidProperties:Name; FluidProperties:GlycolConcentration; FluidProperties:Temperatures; FluidProperties:Saturated; FluidProperties:Superheated; FluidProperties:Concentration; HVACTemplate:Thermostat; HVACTemplate:Zone:IdealLoadsAirSystem; HVACTemplate:Zone:BaseboardHeat; HVACTemplate:Zone:FanCoil; HVACTemplate:Zone:PTAC; HVACTemplate:Zone:PTHP; HVACTemplate:Zone:WaterToAirHeatPump; HVACTemplate:Zone:VRF; HVACTemplate:Zone:Unitary; HVACTemplate:Zone:VAV; HVACTemplate:Zone:VAV:FanPowered; HVACTemplate:Zone:VAV:HeatAndCool; HVACTemplate:Zone:ConstantVolume; HVACTemplate:Zone:DualDuct; HVACTemplate:System:VRF; HVACTemplate: System:Unitary; HVACTemplate:System:UnitaryHeatPump:AirToAir; HVACTemplate:System:UnitarySystem; HVACTemplate:System:VAV; HVACTemplate:System:PackagedVAV; HVACTemplate:System:ConstantVolume; HVACTemplate: System:DualDuct; HVACTemplate:System:DedicatedOutdoorAir; HVACTemplate:Plant:ChilledWaterLoop; HVACTemplate:Plant:Chiller; HVACTemplate:Plant:Chiller:ObjectReference; HVACTemplate:Plant:Tower; HVACTemplate:Plant:Tower:ObjectReference; HVACTemplate:Plant:HotWaterLoop; HVACTemplate:Plant:Boiler; HVACTemplate:Plant:Boiler:ObjectReference; HVACTemplate:Plant:MixedWaterLoop; UtilityCost:Tariff; UtilityCost:Qualify; UtilityCost:Charge:Simple; UtilityCost:Charge:Block; UtilityCost:Ratchet; UtilityCost:Variable; UtilityCost:Computation; UtilityCost:Tariff Examples; UtilityCost:Tariff Reporting; ComponentCost:Lineltem.

1. A computerized system adapted to operate on one or more computers having memory and a processor and in communication with one or more input ports, one or more output ports, and one or more databases, the system specially adapted to create an electronic building description for use in running energy simulations of a building on a computerized simulation tool, the system comprising:
a module adapted to allow a user to input into a computer known simulation parameter data regarding the building;
a module adapted to generate an augmented input data file (IDF) comprising the known simulation parameter data and digital information representing a locus of all possible simulation parameter data values for each of a plurality of unknown simulation parameters;
one or more modules adapted to employ an evolutionary optimization algorithm adapted to randomly select possible simulation parameter data values from among the locus of possible simulation parameter data values for each of a plurality of unknown simulation parameters, and then generate, test and compare successive generations of trial IDFs created at least in part from the selected simulation parameter data values, wherein the evolutionary optimization algorithm tends to cause the accuracy of the successive generations of trial IDFs to increase; and
a module adapted to output to a user the trial IDF with the highest measured accuracy.

2. The computerized system of claim 1, wherein the one or more modules adapted to employ an evolutionary optimization algorithm comprises: a module adapted to parse the augmented IDF into a first generation of trial IDFs where the computer assigns to each unknown simulation parameter of each trial IDF one value selected from the locus of all possible simulation parameter data values for that unknown simulation parameter.

3. The computerized system of claim 2, wherein the one or more modules adapted to employ an evolutionary optimization algorithm comprises: a module adapted to run each of the first generation of trial IDFs through a computerized simulation tool that generates energy reports for each trial IDF estimating energy use of the building during that predetermined time period by processing simulation parameter data values in each trial IDF in combination with recorded weather data regarding actual weather conditions near the building during said time period.

4. The computerized system of claim 3, wherein the one or more modules adapted to employ an evolutionary optimization algorithm comprises: a module adapted to compare each energy report to data corresponding to the actual energy usage of the building during said time period and to rank each energy report according to its accuracy in estimating the energy use of the building.

5. The computerized system of claim 4, wherein the one or more modules adapted to employ an evolutionary optimization algorithm comprises: a module adapted to generate lists of values used for each of the unknown simulation parameters by a subset of the first generation of trial IDFs that were ranked superior to other of the first generation of trial IDFs in accuracy in estimating the energy use of the building.

6. The computerized system of claim 5, wherein the one or more modules adapted to employ an evolutionary optimization algorithm comprises: a module adapted to parse the augmented IDF into a second generation of trial IDFs where the computer assigns to each unknown simulation parameter of each trial IDF one value selected from said computer-generated list of values corresponding to that unknown simulation parameter.

7. The computerized system of claim 6, wherein the one or more modules adapted to employ an evolutionary optimization algorithm comprises: a module adapted to run each of the second generation of trial IDFs through the computerized simulation tool that generates energy reports for each trial IDF estimating energy use of the building during that predetermined time period by processing simulation parameter data values in each trial IDF in combination with recorded weather data regarding actual weather conditions near the building during said time period.

8. The computerized system of claim 7, wherein the one or more modules adapted to employ an evolutionary optimization algorithm comprises: a module adapted to compare each energy report to data corresponding to the actual energy usage of the building during said time period and to rank each energy report according to its accuracy in estimating the energy use of the building.

9. The computerized system of claim 8, wherein the one or more modules adapted to employ an evolutionary optimization algorithm comprises: a module adapted to generate lists of values used for each of the unknown simulation parameters by a subset of the second generation of trial IDFs that were ranked superior to other of the second generation of trial IDFs in accuracy in estimating the energy use of the building.

10. The computerized system of claim 9, wherein the one or more modules adapted to employ an evolutionary optimization algorithm comprises: one or more modules adapted to repeat the foregoing parsing, running, and comparing steps in successive generations until a predetermined number of generations is reached or until the accuracy of successive generations stops improving by a predetermined amount.

11. A computerized system adapted to operate on one or more computers having memory and a processor and in communication with one or more input ports, one or more output ports, and one or more databases, the system specially adapted to create an electronic building description for use in running energy simulations of a building on a computerized simulation tool, the system comprising:
a module adapted to allow a user to input into a computer known simulation parameter data regarding the building;
a module adapted to generate an augmented input data file (IDF) comprising the known simulation parameter data and digital information representing a locus of all possible simulation parameter data values for each of a plurality of unknown simulation parameters;
a module adapted to parse the augmented IDF into a first generation of trial IDFs where the computer assigns to each unknown simulation parameter of each trial IDF one value selected from the locus of all possible simulation parameter data values for that unknown simulation parameter;
a module adapted to run each of the first generation of trial IDFs through a computerized simulation tool that generates energy reports for each trial IDF estimating energy use of the building during that predetermined time period by processing simulation parameter data values in each trial IDF in combination with recorded weather data regarding actual weather conditions near the building during said time period;
a module adapted to compare each energy report to data corresponding to the actual energy usage of the building during said time period and to rank each energy report according to its accuracy in estimating the energy use of the building;
a module adapted to generate lists of values used for each of the unknown simulation parameters by a subset of the first generation of trial IDFs that were ranked superior to other of the first generation of trial IDFs in accuracy in estimating the energy use of the building;
a module adapted to parse the augmented IDF into a second generation of trial IDFs where the computer assigns to each unknown simulation parameter of each trial IDF one value selected from said computer-generated list of values corresponding to that unknown simulation parameter;
a module adapted to run each of the second generation of trial IDFs through the computerized simulation tool that generates energy reports for each trial IDF estimating energy use of the building during that predetermined time period by processing simulation parameter data values in each trial IDF in combination with recorded weather data regarding actual weather conditions near the building during said time period;
a module adapted to compare each energy report to data corresponding to the actual energy usage of the building during said time period and to rank each energy report according to its accuracy in estimating the energy use of the building;
a module adapted to generate lists of values used for each of the unknown simulation parameters by a subset of the second generation of trial IDFs that were ranked superior to other of the second generation of trial IDFs in accuracy in estimating the energy use of the building;
one or more modules adapted to repeat the foregoing parsing, running, and comparing steps in successive generations until a predetermined number of generations is reached or until the accuracy of successive generations stops improving by a predetermined amount; and
a module adapted to output to a user the trial IDF with the highest measured accuracy.

12. A method of creating an electronic building description adapted for use in running energy simulations of a building on a computerized simulation tool, comprising the steps of:
inputting into a computer module known simulation parameter data regarding the building;
causing a computer to generate an augmented input data file (IDF) comprising the known simulation parameter data and digital information representing a locus of all possible simulation parameter data values for each of a plurality of unknown simulation parameters;
causing a computer to parse the augmented IDF into a first generation of trial IDFs where the computer assigns to each unknown simulation parameter of each trial IDF one value selected from the locus of all possible simulation parameter data values for that unknown simulation parameter;
causing a computer to run each of the first generation of trial IDFs through a computerized simulation tool that generates energy reports for each trial IDF estimating energy use of the building during that predetermined time period by processing simulation parameter data values in each trial IDF in combination with recorded weather data regarding actual weather conditions near the building during said time period;
causing a computer to compare each energy report to data corresponding to the actual energy usage of the building during said time period and to rank each energy report according to its accuracy in estimating the energy use of the building;
causing a computer to generate lists of values used for each of the unknown simulation parameters by a subset of the first generation of trial IDFs that were ranked superior to other of the first generation of trial IDFs in accuracy in estimating the energy use of the building;
causing a computer to parse the augmented IDF into a second generation of trial IDFs where the computer assigns to each unknown simulation parameter of each trial IDF one value selected from said computer-generated list of values corresponding to that unknown simulation parameter;
causing a computer to run each of the second generation of trial IDFs through the computerized simulation tool that generates energy reports for each trial IDF estimating energy use of the building during that predetermined time period by processing simulation parameter data values in each trial IDF in combination with recorded weather data regarding actual weather conditions near the building during said time period;
causing a computer to compare each energy report to data corresponding to the actual energy usage of the building during said time period and to rank each energy report according to its accuracy in estimating the energy use of the building;
causing a computer to generate lists of values used for each of the unknown simulation parameters by a subset of the second generation of trial IDFs that were ranked superior to other of the second generation of trial IDFs in accuracy in estimating the energy use of the building;
causing one or more computers to repeat the foregoing parsing, running, and comparing steps in successive generations until a predetermined number of generations is reached or until the accuracy of successive generations stops improving by a predetermined amount; and
causing a computer to output the trial IDF with the highest measured accuracy.

13. The method of creating an electronic building description adapted for use in running energy simulations of a building on a computerized simulation tool of claim 12, further comprising the step of:
running an energy simulation of the building on a computerized simulation tool by inputting into the computerized simulation tool said trial IDF with the highest measured accuracy.
